(19) United States
(12) Patent Application Publication
(10) Pub. No.: US 2025/0203316 A1
(43) Pub. Date: Jun. 19, 2025

(54) METHODS, APPARATUS, AND SYSTEMS FOR PROCESSING AUDIO SCENES FOR AUDIO RENDERING

(71) Applicant: DOLBY INTERNATIONAL AB, Dublin (IE)

(72) Inventors: Panji Setiawan, Munich (DE); Leon Terentiv, Erlangen (DE); Daniel Fischer, Fuerth (DE); Christof Joseph Fersch, Neumarkt (DE)

(73) Assignee: DOLBY INTERNATIONAL AB, Dublin (IE)

(21) Appl. No.: 18/844,368

(22) PCT Filed: Mar. 2, 2023
(86) PCT No.: PCT/EP2023/055380

§ 371 Date: Sep. 5, 2024

Related U.S. Application Data
(60) Provisional application No. 63/318,080, filed on Mar. 9, 2022.
(60) Provisional application No. 63/413,719, filed on Oct. 6, 2022.

(51) Int. Cl. H04S 7/00; G10L 19/008

(52) U.S. Cl. CPC H04S 7/305; G10L 19/008; H04S 2400/11

(57) ABSTRACT

The disclosure relates to a method of processing audio scene information for audio rendering. The method includes receiving an audio scene description, the audio scene description comprising a representation of a three-dimensional audio scene and information on a source location of a sound source within the audio scene: receiving an indication of a listener location of a listener within the audio scene: obtaining diffraction information relating to an acoustic diffraction path within the audio scene between the source location and the listener location: performing audio rendering for the sound source based on the diffraction information; and outputting a representation of the diffraction information. The disclosure further relates to corresponding apparatus, computer programs, and computer-readable storage media.

### CROSS-REFERENCE TO RELATED APPLICATION

This application claims priority of the U.S. Provisional Application No. 63/318,080 filed Mar. 9, 2022 and U.S. Provisional Application No. 63/413,719 filed on 6 Oct. 2022, all of which is incorporated herein by reference in its entirety.

### TECHNICAL FIELD

The present disclosure relates to techniques of processing audio scene information for audio rendering. In particular, the present disclosure is directed to voxel-based scene representation and audio rendering.

### BACKGROUND

The Moving Picture Experts Group (MPEG) is an alliance of working groups established jointly by the International Organization for Standardisation (ISO) and International Electrotechnical Commission (IEC), that sets standards for media coding, including audio coding. MPEG is organized under ISO/IEC SC 29, and the audio group is presently identified as working group (WG) 6. WG 6 is currently working on a new audio standard (also known as MPEG-I Immersive Audio, ISO/IEC 23090-4).

The new MPEG-I standard enables an acoustic experience from different viewpoints and/or perspectives or listening positions by supporting scenes and various movements around such scenes, such as movements using various degrees of freedom such as three degrees of freedom (3DOF) or six degrees of freedom (6DoF) in Virtual reality (VR), augmented reality (AR), mixed reality (MR) and/or extended reality (XR) applications. A 6 DoF interaction extends a 3 DoF spherical video/audio experience that is limited to head rotations (pitch, yaw, and roll) to include translational movement (forward/back, up/down, and left/right), to allow for navigation within a virtual environment (e.g., physically walking inside a room), in addition to the head rotations.

For audio rendering in VR, AR, MR and XR applications, object-based approaches have been widely employed by representing a complex auditory scene as multiple separate audio objects, each of which is associated with parameters or metadata defining a location/position and trajectory of that object in the scene. Alternatively audio rendering in such environments also uses higher order ambisonics (HOA). However, a new usage of “voxels” for rendering audio scenes is now being explored, such as for use of new immersive audio experiences. Voxels for audio rendering are relevant for media environments implemented in both hardware and software, such as video game and/or VR, AR, MR and XR environments.

A Voxel is a space volume with acoustic properties or audio rendering instructions assigned to it. Voxel size may be an encoder configuration parameter, and it can be (manually or automatically) selected according to a scene geometry level of details (e.g., in the range of 10 cm-1 m).

Voxels for audio rendering can be obtained by:
voxelization (or conversion) of a mesh-based scene representation
from scene representation used for scene generation (or even video rendering) (e.g., by down-sampling of voxels of smaller size)

However, conventional approaches for providing realistic sound for user experiences (including those involving movement) in VR, AR, MR and XR environments using voxels still remain challenging and computationally complex.

Typical techniques for diffraction modeling in three-dimensional audio scenes, such as for computer-mediated reality applications, require re-calculation of diffraction paths and other diffraction information whenever any of the audio scene, the user location, or the audio source location change. For example, the diffraction path may change when the user and/or the audio source move through the three-dimensional audio scene. Further, the diffraction path may change when the audio scene itself changes, for example by indicating a door or window that opens or closes, or the like. Frequent re-calculations of diffraction paths may be computationally expensive, which requires comparatively powerful computation devices for implementing computer-mediated reality applications and/or may negatively affect user experience in some cases.

There is thus a need for improved techniques for diffraction modeling in three-dimensional audio scenes, particularly three-dimensional audio scenes utilizing voxels. There is a particular need for such techniques that can reduce a computational burden on devices (e.g., decoders, renderers) implementing such techniques.

### SUMMARY

In view of this need, the present disclosure provides methods of processing audio scene information (in particular, voxel-based audio scene information) for audio rendering, apparatus for processing audio scene information for audio rendering, computer programs, and computer-readable storage media, having the features of the respective independent claims.

One aspect of the present disclosure relates to a method of processing audio scene information for audio rendering. The method may include receiving an audio scene description. The audio scene description may include a representation of a three-dimensional audio scene and information on a source location of a sound source within the audio scene. The method may further include receiving an indication of a listener location of a listener within the audio scene. The method may further include obtaining diffraction information relating to an acoustic diffraction path within the audio scene between the source location and the listener location. The method may further include performing audio rendering for the sound source based on the diffraction information. The method may yet further include outputting a representation of the diffraction information. Output of the representation of the diffraction information may be to at least one external (e.g., shared) data source or repository, enabling reuse of the diffraction information by external rendering or decoder instances.

The proposed method provides an interface (e.g., data interface for exchanging data, including for example a predefined format for the representation of the diffraction information) for sharing generated/calculated diffraction information between rendering instances (or decoder instances), in addition to local re-use. The interface may be implemented in a software format that may be executed on one or more hardware platforms. For example, the interface may be a graphical user interface that displays information and/or allows for user interaction. This can be used for establishing a framework of rendering instances that share locally generated (or even externally retrieved) diffraction information among themselves. Thereby, required computational power for rendering at each rendering instance can be reduced. Importantly, the diffraction information is generated at the decoder side and therefore is automatically ensured to be applicable to real-life use cases and situations. In particular, a large amount of diffraction information will be available for listener locations that are frequently visited by actual users in the audio scene. Accordingly, a storage amount for storing the representations of diffraction information (e.g., shared/physical storage or bitstream) can be efficiently used, and will be used to store, to large extent, representations of diffraction information that are practically relevant.

In some embodiments, outputting the representation of the diffraction information may include outputting a data element comprising the diffraction information and information on a scene state. The scene state may include the audio scene description and the listener location. Output of the data element may be to the bitstream or storage. In particular, output may be to at least one external (e.g., non-local, in particular, shared) data source or repository (e.g., shared/cloud memory or bitstream), enabling reuse of the diffraction information by external rendering instances.

The diffraction information may be reused by the same device/decoder/render at a later point in time, or it may be used by other devices/decoders/renderers. The scene state included in the data element can be used by the device/decoder/renderer to determine whether available diffraction information is applicable to a given configuration of the audio scene and the listener in it, or put differently, whether diffraction information is available for the given configuration.

In some embodiments, the representation of the diffraction information may be output to a bitstream (outgoing bitstream) and/or to a storage.

In some embodiments, the diffraction information may be output for later re-use for audio rendering by the same rendering instance or for later re-use by another rendering instance.

In some embodiments, the representation of the diffraction information may be output as part of a voxSceneDiffractionPreComputedPathData( ) syntax element according to the MPEG-I standard, or any subsequent version of the MPEG-I standard.

In some embodiments, the diffraction information may be indicative of a virtual source location of a virtual sound source. This virtual sound source may be chosen to “encapsulate” application of diffraction and/or occlusion effects to the sound source, so that the virtual sound source, when directly rendered, sounds the same or substantially the same as the sound source when rendered with diffraction and/or occlusion processing. The virtual source location may have the same direction (e.g., azimuth, or azimuth and elevation), when seen from the listener location, as the first location (diffraction corner) on or on the proximity of the acoustic diffraction path for which the diffraction path changes direction and for which the direct line from the diffraction corner voxel to the listener voxel location is not occluded. The virtual source distance may correspond to a length of the diffraction path. The diffraction information may comprise indications of Cᵥₒₓ and rᵢₙ defined below, where in short, Cᵥₒₓ indicates a location (e.g., voxel location) of the diffraction corner and rᵢₙ indicates the length of the diffraction path.

In some embodiments, the representation of the three-dimensional audio scene may be a voxel-based representation. Then, the representation of the three-dimensional audio scene may include one or more indications of cuboid volumes in a voxel grid and wherein each such indication may include information on a pair of extreme-corner voxels defining the cuboid and information on a common voxel property of the voxels in the cuboid volume. This allows for a more efficient voxel-based representation of the three dimensional audio scene.

In some embodiments, the information on the pair of extreme-corner voxels of the cuboid volume may include indications of respective voxel indices assigned to the extreme-corner voxels. Here, the voxels of the voxel-based audio scene representation may have uniquely assigned consecutive voxel indices. This allows for a more efficient representation of voxel coordinates.

In some embodiments, the representation of the three-dimensional audio scene may be a voxel-based representation. Then, the diffraction information may include an indication of a location of a voxel that is located on or on the proximity of the diffraction path and an indication of a length of the diffraction path. Further, the indication of the location of the voxel located on or on the proximity of the diffraction path may be an indication of a voxel index assigned to said voxel, where the voxels of the voxel-based audio scene representation may have uniquely assigned consecutive voxel indices.

In some embodiments, the method may further include determining a (current) scene state based on the audio scene description and the listener location. This current scene state can then be used for determining whether pre-computed diffraction information is available for the current configuration of the audio scene and the current listener location.

In some embodiments, the method may further include determining whether the current scene state corresponds to a known scene state for which precomputed diffraction information can be retrieved. The precomputed diffraction information may be retrieved from a bitstream (incoming bitstream) or storage (including, in particular, external storage, such as shared/cloud storage), for example.

In some embodiments, determining whether the current scene state corresponds to a known scene state may include determining a hash value based on the current scene state. This may further include comparing the determined hash value to hash values for known scene states.

In some embodiments, the method may further include, if it is determined that the current scene state corresponds to a known scene state, determining the diffraction information by extracting the precomputed diffraction information for the known scene state from a bitstream or storage (e.g., local memory, cache, external memory, shared memory, cloud-implemented memory, etc.).

In particular, the precomputed diffraction information may be retrieved, at least in part, from an external data source or repository.

In some embodiments, the method may further include, if it is determined that the current scene state does not correspond to a known scene state, determining the diffraction information using a pathfinding algorithm, based on the source location, the listener location, and the representation of the three-dimensional audio scene.

In some embodiments, the method may further include receiving a look up table or an entry of a look up table from a bitstream or storage, the look up table comprising a plurality of items of precomputed diffraction information, each associated with a respective known scene state. The LUT may thus relate to or comprise a plurality of the aforementioned data items. The known scene state may include a known audio scene description and a known listener location.

In some embodiments, the representation of the three-dimensional audio scene may be a voxel-based representation.

According to another aspect, a method of compressing an audio scene for three-dimensional audio rendering is provided. The method may include obtaining a voxelized representation of the audio scene, the voxelized representation comprising a plurality of voxels arranged in a voxel grid, each voxel having an associated voxel property. The method may further include determining, among the voxels of the voxelized representation, a set of voxels that forms a connected geometric region on the voxel grid, wherein the voxels in the geometric region share a common voxel property. The method may yet further include generating a representation of the audio scene based on the determined set of voxels.

In some embodiments, the geometric region may have a cuboid shape. Then, the method may further include determining, from the plurality of voxels of the voxelized representation, at least a first boundary voxel and a second boundary voxel for the set of voxels. Therein, the first boundary voxel and the second boundary voxel may define the cuboid shape of the geometric region.

In some embodiments, the voxel property of each voxel may include an acoustic property associated with that voxel and/or a set of audio rendering instructions assigned to that voxel. Further, the common voxel property for the voxels in the geometric region may include a common acoustic property associated with those voxels and/or a common set of audio rendering instructions assigned to those voxels.

In some embodiments, the method may further include determining, for the geometric region, at least one scene element parameter including one or more of: a scene element identifier, an acoustic property identifier and/or audio rendering instruction set identifier, and indices of the corresponding first and second boundary voxels defining the geometric region. Here, a scene element is understood to relate to a geometric region together with its corresponding voxel property (e.g., material property and/or rendering instructions), and optionally an identifier (e.g., scene element identifier).

In some embodiments, the method may further include applying entropy coding and/or lossy coding in a sequential (taking all data to process) or progressive (taking parts of the data) manner to the at least one scene element parameter for the geometric region.

In some embodiments, the method may further include outputting a bitstream including the at least one scene element parameter for determining the set of voxels associated with the geometric region for a compressed representation of the audio scene based on the determined set of voxels.

In some embodiments, the geometric region may be related to a scene element within the audio scene.

In some embodiments, the audio scene may include a large scene represented by the determined set of voxels. The large scene may include a set of sub-scenes. Each of the sub-scenes may correspond to a subset of the determined set of voxels. Then, the method may further include determining, among the determined set of voxels, the subsets of voxels for the corresponding sub-scenes.

In some embodiments, the method may further include applying interpolation of and/or applying filtering on audio properties and renderer instructions of voxels in time and/or space.

In some embodiments, the method may further include redefining voxel properties for a subset of the set of voxels associated with a scene sub-element in the geometric region for overwriting the subset with the redefined voxel properties. Here, a scene sub-element is understood to relate to a scene element with a geometric region that is included (e.g., fully included) within the geometric region of another scene element.

In some embodiments, the method may further include determining a superset of voxels including the determined set of voxels. The determined set of voxels may be associated with a scene sub-element within the geometric region. Then, the method may further include assigning a new voxel property to the determined set of voxels and overwriting the voxel property of the determined set of voxels with the new voxel property.

In some embodiments, the method may further include determining a voxel size for representing the geometric region, wherein the voxel size is based on a number of voxels along a scene dimension.

According to another aspect, an apparatus for processing audio scene information for audio rendering is provided. The apparatus may include a processor and a memory coupled to the processor and storing instructions for the processor. The processor may be configured to perform all steps of the methods according to preceding aspects and their embodiments.

According to a further aspect, a computer program is described. The computer program may comprise executable instructions for performing the methods or method steps outlined throughout the present disclosure when executed by a computing device (e.g., processor).

According to another aspect, a computer-readable storage medium is described. The storage medium may store a computer program adapted for execution on a computing device (e.g., processor) and for performing the methods or method steps outlined throughout the present disclosure when carried out on the computing device.

It should be noted that the methods and systems including its preferred embodiments as outlined in the present disclosure may be used stand-alone or in combination with the other methods and systems disclosed in this document. Furthermore, all aspects of the methods and systems outlined in the present disclosure may be arbitrarily combined. In particular, the features of the claims may be combined with one another in an arbitrary manner.

It will be appreciated that apparatus features and method steps may be interchanged in many ways. In particular, the details of the disclosed method(s) can be realized by the corresponding apparatus, and vice versa, as the skilled person will appreciate. Moreover, any of the above statements made with respect to the method(s) (and, e.g., their steps) are understood to likewise apply to the corresponding apparatus (and, e.g., their blocks, stages, units), and vice versa.

### BRIEF DESCRIPTION OF THE DRAWINGS

The invention is explained below in an exemplary manner with reference to the accompanying drawings, wherein

FIG. 1 schematically illustrates an example of a processing chain for processing audio scene information for audio rendering;

FIG. 2 schematically illustrates an example of a diffraction path for a source location and a listener location in a voxel-based three-dimensional audio scene;

FIG. 3 is a flowchart illustrating an example of a method of processing audio scene information for audio rendering according to embodiments of the disclosure;

FIG. 4 is a flowchart illustrating an example of an implementation detail of the method of FIG. 3 according to embodiments of the disclosure;

FIG. 5 to FIG. 7 schematically illustrate examples of processing chains for processing audio scene information for audio rendering according to embodiments of the disclosure;

FIG. 8 is a diagram illustrating complexity measures as functions of time for different operating modes/implementations of processing audio scene information for audio rendering according to embodiments of the disclosure;

FIG. 9 schematically illustrates an example of a possible use case for techniques according to embodiments of the disclosure;

FIGS. 10A-10C schematically illustrate examples of part of a voxel-based audio scene according to embodiments of the disclosure;

FIG. 11 schematically illustrates an example of a voxel-based audio scene to which embodiments of the disclosure may be applied; and

FIG. 12 is a block diagram schematically illustrating an example of an apparatus implementing methods according to embodiments of the disclosure.

### DETAILED DESCRIPTION

In the following, example embodiments of the disclosure will be described with reference to the appended figures. Identical elements in the figures may be indicated by identical reference numbers, and repeated description thereof may be omitted.

### Voxel-Based Audio Scene Representations

First, an overview over voxel-related concepts for representation of audio scenes will be given.

### What is a Voxel for Audio Rendering?

A voxel is understood as a space volume with acoustic properties or audio rendering instructions assigned to it.

### What is a Voxel Size for Audio Rendering?

The voxel size may be an encoder configuration parameter. It may be (manually or automatically) selected according to a scene geometry level of details (e.g., in the range of 10 cm-1 m).

### How Large Audio Scenes can be Handled?

Large audio scenes do not necessarily result in a large number of voxels and high rendering complexity. For example, a large audio scene can be represented as
a set of independent sub-scenes (and method for “teleport” between these representations without a renderer “re-start”)
a set of scenes updates (based on the user position)

### How can Discontinuity Issues Caused by Voxel Granularity be Handled?

Any strong discontinuities in sound levels (and jumps of diffracted signal direction) can be avoided by application of interpolation (e.g., in time and space).

### How to Represent Voxel-Based Audio Scenes?

Any voxel-based representation of an audio scene may contain an indication of voxels that are not transmission voxels (e.g., that are occluder voxels), i.e., voxels in which sound cannot propagate or cannot freely propagate-a representation of occluding geometries. This indication may relate to an indication of coordinates (e.g., center coordinates, corner coordinates, etc.) of the respective voxels. The coordinates of these voxels may be represented by grid indices, for example. Additionally, the voxel-based representation may include indications of material properties of the voxels that are not transmission voxels, such as absorption coefficients, reflection coefficients, etc. In addition to the occluder voxels, the voxel-based representation may also indicate transmission voxels (e.g., air voxels), i.e., voxels in which sound can propagate-a representation of sound propagation media. Accordingly, some implementations of voxel-based representations of audio scenes may include, for each voxel in a predefined section of space (e.g., within boundaries enclosing the audio scene), and indication of a respective material property.

### Techniques for Processing Audio Scene Information

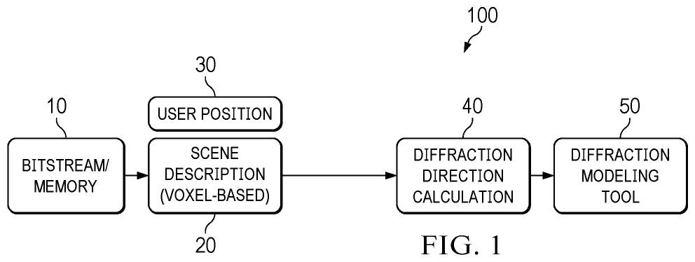

FIG. 1 schematically illustrates a processing chain 100 that can be used for processing audio scene information for audio rendering. Specifically, the processing chain 100 can be used for converting voxel related data into parameters and signals needed for auralization (or audio rendering in general). The processing chain 100 may be implemented in software, hardware, or combinations thereof. For example, the processing chain 100 may be implemented by a renderer/decoder coupled to AR/VR/MR/XR equipment, such as AR/VR/MR/XR goggles.

Specific implementations may include game consoles, set-top-boxes, personal computers, etc., The processing chain receives an audio scene description 20 from a bitstream (or storage/memory) 10. The audio scene description 20 may comprise a representation of a three-dimensional audio scene and information on a source location of a sound source within the audio scene. The representation of the three-dimensional audio scene may be voxel-based, for example.

The processing chain 100 further receives an indication of a user position (listener location) 30 of a user (listener) within the audio scene. The audio scene description 20 and the user position 30 are provided to a diffraction direction calculation block (diffraction calculation block) 40 for determining (e.g., calculating) diffraction information. The diffraction information may relate to an acoustic diffraction path within the audio scene between the source location and the listener location. The diffraction information is then provided to a diffraction modeling tool 50 for applying diffraction modeling and optionally occlusion modeling, based on the diffraction information. The occlusion modeling calculates attenuation gains for the direct line between the listener and an audio source. The diffraction modeling tool 50 may output auralized audio data (3DoF auralizer data) that includes, for example, a location of an object to be rendered, an orientation, and frequency dependent gains. The diffraction modeling tool output may be further processed by other rendering stages such as Doppler, Directivity, Distance Attenuation, etc., In general, the diffraction modeling tool 50 may be said to output diffraction information, as detailed below. The auralized audio data may then be used for audio replay, for example.

In summary, a processing chain as shown in FIG. 1 may be used to convert voxel related data into the parameters for parameters and signals for auralization. The diffraction direction calculation block 40 and the diffraction modeling tool 50 may be seen as non-limiting examples of rendering tools. In general, the rendering tools may generate 3DoF auralizer data.

As noted above, the scene description may include a voxel matrix and associated coefficients (e.g., reflection coefficients, occlusion coefficients, absorption coefficients, transmission coefficients etc.). These coefficients may be indicative of a material or material property of the respective voxel. The rendering tools may include, for example, occlusion and diffraction modelling tools. The 3DoF auralizer data may include, for example, object position, orientation and frequency dependent gains.

As noted above, the voxel-based representation of the three-dimensional audio scene defines psycho-acoustically relevant geometric elements and sound propagation media. In some implementations, the scene description may use the following parameters/interfaces (e.g., the following agreed upon data format, or agreed upon point of data exchange) to provide the information to rendering tools:

### Scene Size:

in absolute units (e.g., meters)
in number of voxels and/or voxel size

### Scene Anchors:

in terms of coordinate anchors (to map absolute coordinates to voxel indices)
in terms of scene anchors (to map sub-scene to sub-set of voxels)

### Scene Content Data:

reference to material properties that approximates acoustic effects caused by occluders (sound obstacles) located in the corresponding volume (e.g., coefficients for transmission, reflection, etc.)
reference to sound propagation media properties that approximates an acoustic effect caused by media located in the corresponding volume (e.g., speed of sound, energy absorption, distance attenuation curve, etc.)
rendering control parameter describing intended occlusion modelling effects E.g., “global” or “local” occluder type that determines the length (and shape) of occlusion effect shadow behind this voxel
rendering control parameter describing intended sound diffraction modelling effects E.g., voxel type that controls/causes the change of sound direction (i.e., path of the diffracted sound cannot penetrate this volume)
content control parameters describing audio signal relevance and scene authoring E.g., audio signal IDs and/or signal gains the determines which signal is perceptually relevant (rendered) in the corresponding volume
rendering control parameter describing intended reverberation modelling effects E.g., voxel type that controls reverberation settings (e.g., RT60, DDR, RIR, etc.)

### Scene Content Updates:

referenced to update triggering events

All data can be audio object dependent (to support content creator intent in flexible audio scene authoring).

The 3DoF auralizer data may include the following information:
parameters and associated signals for the set of audio objects (and HOA)
   parameters include the metadata output of the rendering tools (i.e., position, orientation and gains simulating effects of occlusion, diffraction, early reflections, parameters for reverberation coefficients, IR, etc.)
   associated signals represent the audio output of the rendering tools (i.e., downmixed or replicated audio signals)
scene state identifier (i.e., metadata allowing to map the scene description and user input to the 3DoF auralizer data)

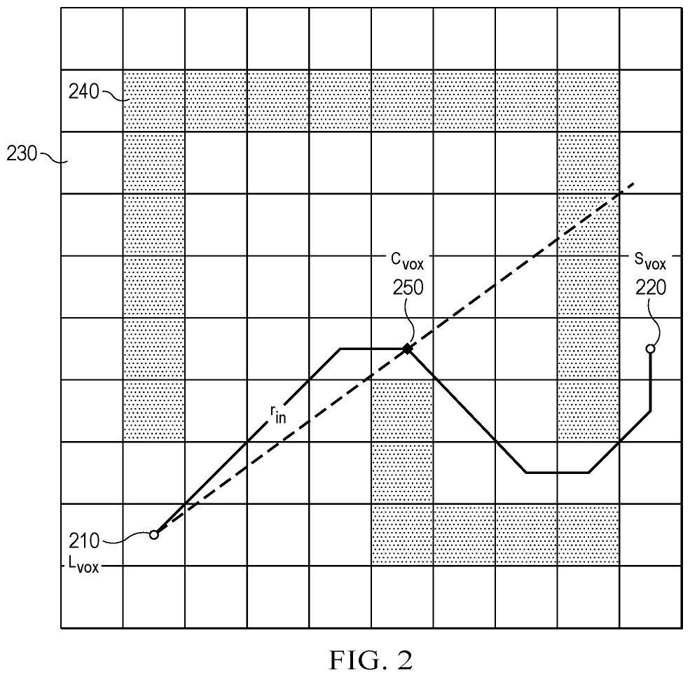

FIG. 2 illustrates an example of a possible scene state and a diffraction path for this scene state. It is understood that the scene state relates to or comprises the listener location 210 and the audio scene description (including the representation of the three-dimensional audio scene and the source location 220).

The example of FIG. 2 relates to a voxel based representation of the three-dimensional audio scene. This voxel based representation indicates “air” voxels or empty voxels (i.e., voxels in which sound can propagate, or transmission voxels) 230 and occluder voxels 240 (i.e., voxels in which sound cannot propagate or cannot freely propagate). Accordingly, occluder voxels may be understood to relate to voxels filled with a material other than air, and that can reflect, block, or otherwise alter sound propagation. For the occluder voxels 240, the representation may further indicate respective transmission, reflections coefficients and potentially absorption coefficients relating to material properties of these voxels. These coefficients may be linked to ID's or indices of their respective voxels in the voxel-based representation. In general, the voxel based representation may define psycho-acoustically relevant geometric elements and sound propagation media in the audio scene.

A listener location 210 is indicated by a parameter L_{VOX} and a source location 220 is indicated by another parameter S_{VOX}.

A diffraction path between the source location 220 and the listener location 210 may be determined using a pathfinding algorithm that takes the listener location 210, the source location 220, and the representation of the three-dimensional audio scene (or a two-dimensional representation, e.g., 2D projection or 2D matrix, derived therefrom) as inputs. For example, an algorithm for determining the diffraction information may take the listener location 210, the source location 220, and the representation of the three-dimensional audio scene as inputs and may output a location of a diffraction corner 250, indicated by Cᵥₒₓ and the variable rᵢₙ representing the length of the diffraction path. For example, the diffraction information may be determined based on:

[Cᵥₒₓ,rᵢₙ]=DiffractionDirectionCalculation(Lᵥₒₓ,Sᵥₒₓ,VoxDataDiffractionMap)

where DiffractionDirectionCalculation indicates the algorithm for determining the diffraction information (“pathfinding algorithm”) and VoxDataDiffractionMap indicates the voxel-based representation of the three-dimensional audio scene or a processed version thereof (e.g., 2D projection or 2D matrix derived therefrom). C_{VOX} is understood to indicate the coordinates of the diffraction corner (e.g., coordinates, voxel/grid coordinates, or voxel/grid indices of the respective voxel including the diffraction corner).

Here, DiffractionDirectionCalculation may involve any viable pathfinding algorithm, such as the Fast traversal algorithm for ray tracing (cf. Amanatides, J. and A. Woo, A Fast Voxel Traversal Algorithm for Ray Tracing. Proceedings of EuroGraphics, 1987. 87.) and the JPS algorithm (cf. Harabor, D. D. and A. Grastien, Online Graph Pruning for Pathfinding On Grid Maps. Proceedings of the Twenty-Fifth AAAI Conference on Artificial Intelligence, 2011.), for example. Further, one may directly apply a 3D path search algorithms to obtain the shortest path between the source location 220 and the listener location 210 using the voxel-based scene representation. Alternatively, one may apply a 2D path search algorithms for this task, using an appropriate 2D projection plane of the 3D voxel-based scene representation. For the indoor (e.g., multiroom room) sound simulation the corresponding 2D projection plane may be similar to a floor plan that describes a “sound propagation path topology”. For outdoor sound simulation scenarios, it may be of interest to consider a second (e.g., vertical) 2D projection plane to account for the diffraction paths going over sound obstacle(s) or occluding structure(s). The path finding approach remains the same for all projection planes, but its application delivers an additional path that can be used for the diffraction modelling.

The pathfinding algorithm is assumed to output a diffraction path that connects the source location 220 to the listener location and that consist of a plurality of straight path segments (line segments) that are sequentially linked end-to-end. Each transition from one path segment to another path segment relates to a change of direction of the diffraction path.

According to the algorithm for determining the diffraction information, the diffraction corner C_{VOX} may be determined as a voxel that lies on or on the proximity of the diffraction path and is adjacent to a corner voxel (in a set of voxels representing corner voxels on the diffraction map, Cₛₑₜ) of the diffraction map (indicated by the voxel-based representation). For example, the diffraction corner Cᵥₒₓ may be selected from a set of voxels (Pₛₑₜ) forming the diffraction path as a voxel that is close to a ‘visible’ (from the listener position Lc) corner voxel (belonging to Cₛₑₜ) causing the path (Pₛₑₜ) to change direction. If there are more than one such corners, the one furthest away from the listener location along the diffraction path (Pₛₑₜ) is selected.

In general, the diffraction path algorithm may be said to determine diffraction information relating to the acoustic diffraction path within the audio scene between the source location and the listener location.

This diffraction information may be sufficient information for the renderer to recover/determine a virtual source location of a virtual audio source that encapsulates effects of acoustic diffraction effects. This is the case for the coordinates of the diffraction corner C_{VOX} and the diffraction path length rᵢₙ. For example, the virtual source location may be recovered by calculating the direction (e.g., azimuth, or azimuth and elevation) of the diffraction corner when seen from the listener location. Using this direction and taking the path length rᵢₙ of the diffraction path as the virtual source distance to the listener location, the virtual source location can be determined.

It is noted that the diffraction information can be represented in different ways. One option, as noted above, is diffraction information including/storing the path length rᵢₙ and the coordinates (e.g., grid coordinates, etc.) of the diffraction corner C_{VOX}.

Based on the above, the following data elements may be defined:

An example of the scene state N₁ may be represented by

N₁={Lᵥₒₓ,S_{VOX},VoxDataDiffractionMap},

i.e., may relate to or comprise the listener location L_{VOX}, the source location S_{VOX} and the voxel-based representation (e.g., VoxDataDiffractionMap) of the audio scene.

A scene state identifier for a scene state N₁ may be defined as

SceneStateIdentifier=HASH(N₁),

where HASH is a hash function that generates a hash value for scene state N₁, e.g., that maps scene states to fixed-size values. In general, the scene state identifier may be said to be indicative of a certain scene state or to identify a certain scene state.

Further, an example of the diffraction information N₂ may be represented by

N₂={Cᵥₒₓ,rᵢₙ},

where rᵢₙ is the path length of the diffraction path and Cᵥₒₓ indicates the location (e.g., voxel location) of the diffraction corner, as described above.

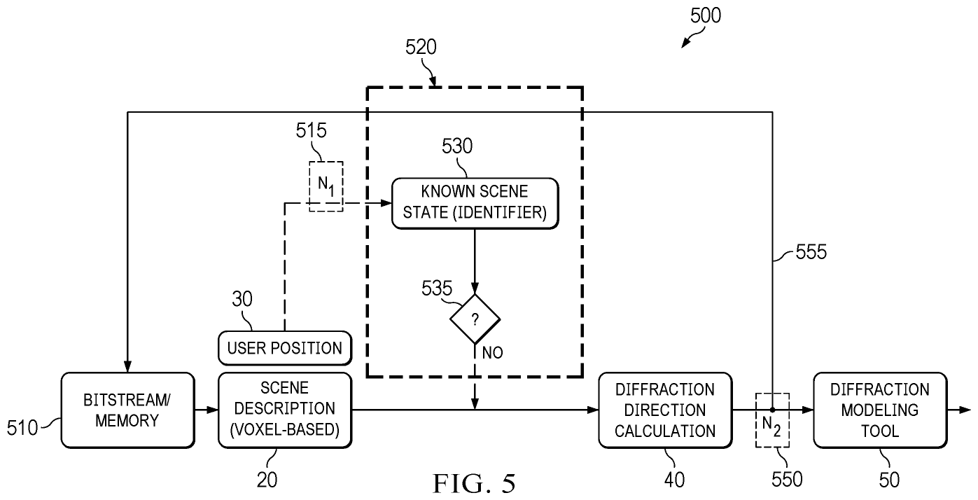

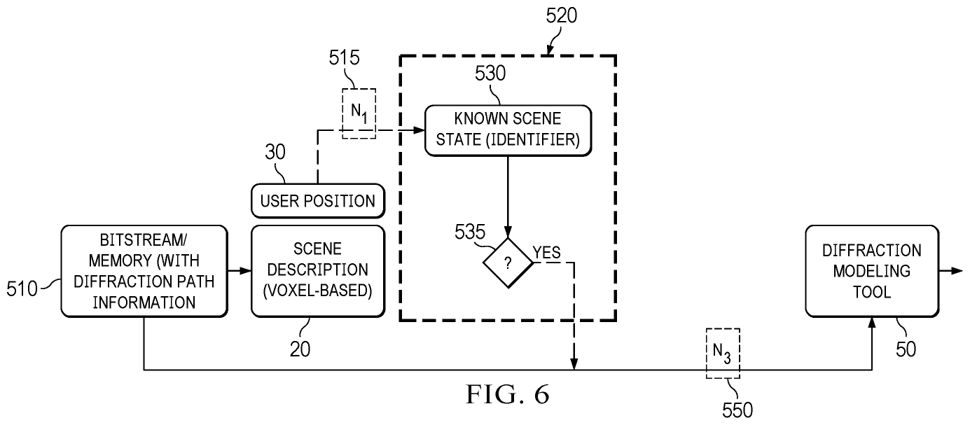

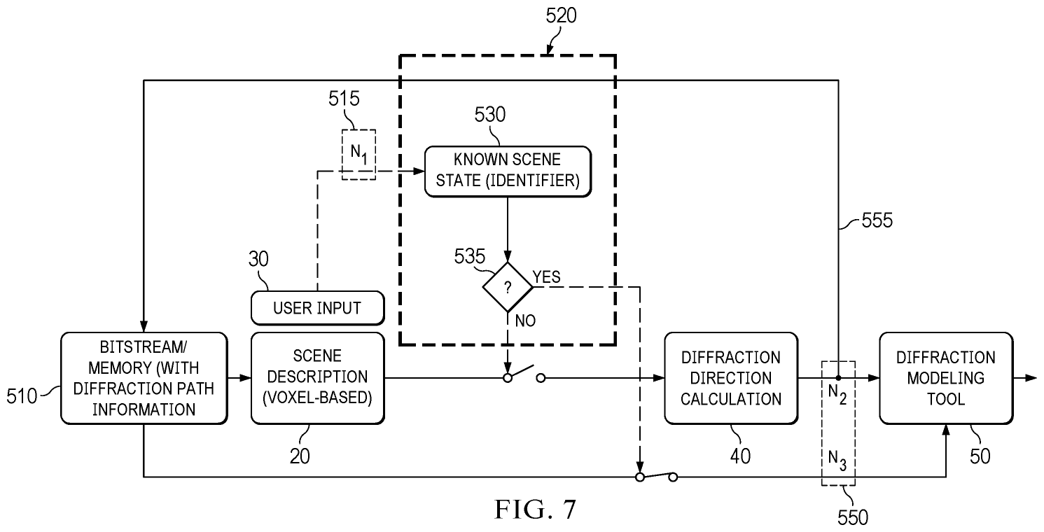

A quantized version of the diffraction information N₂ may be indicated by N₃, where

$${N}_{3} = voxSceneDiffractionPreComputedPathData ( {N}_{1} ) ,$$

$${N}_{3} ( \sim = {N}_{2} ) = DiffractionDirectionCalculation ( {N}_{1} ) ,$$

where voxSceneDiffractionPreComputedPathData( ) is a bitstream syntax that parses the bitstream and retrieves the precomputed (stored and quantized) diffraction information (e.g., generated by the processing chain 500 of FIG. 6) and DiffractionDirectionCalculation( ) denotes a function that performs an online calculation of the diffraction information which may be implemented for example in diffraction direction calculation block 40 in FIG. 5 and FIG. 7.

The diffraction information, for example Cᵥₒₓ and rᵢₙ, may also be seen as relating to 3DOF auralizer data, because user the position voxel coordinates L_{VOX} are fixed.

An example of syntax element voxSceneDiffractionPreComputedPathData( ) according to the MPEG-I standard is given by Table 1. This voxel payload data structure may have the following elements:

| | |
|---|---|
| numberOfVoxDiffractionPathData | This element represents the number of pre-computed |
| | diffraction path data sets. |
| voxDiffractionPathStartVoxelPacked | This element represents the packed form of the variable |
| | voxDiffractionPathStartVoxel indicating the voxel |
| | indices of the path start voxel of the pre-computed |
| | diffraction path (e.g., Sᵥₒₓ or Lᵥₒₓ in FIG. 2). |
| | voxDiffractionPathStartVoxel may be a 2D position on |
| | the diffraction map indicating the start position of the |
| | diffraction path, for example. |
| voxDiffractionPathEndVoxelPacked | This element represents the packed form of the variable |
| | voxDiffractionPathEndVoxel indicating the voxel indices |
| | of the path end voxel of the pre-computed diffraction path |
| | (e.g., Lᵥₒₓ or Sᵥₒₓ in FIG. 2). voxDiffractionPathEndVoxel |
| | may be a 2D position on the diffraction map indicating the |
| | end position of the diffraction path, for example. |
| voxDiffractionPathDataExistFlag | This element indicates whether the diffraction path exists |
| | or not. |
| voxDiffractionSourceDirectionPacked | This element represents the packed form of the variable |
| | voxDiffractionSourceDirection indicating the voxel |
| | indices of the voxel for determining diffracted source |
| | azimuth value. This may correspond to the corner voxel |
| | Cᵥₒₓ, for example. |
| voxDiffractionPathLength | This element represents the diffraction path length on the |
| | diffraction map 2D matrix. This may correspond to the |
| | path length rᵢₙ, for example. |
| Note: | |
| voxSceneDimensions | The number of voxels per each scene dimension. |
| escapedValue( ) | This element implements a general method to transmit an |
| | integer value using a varying number of bits. It features a |
| | two level escape mechanism which allows to extend the |
| | representable range of values by successive transmission |
| | of additional bits. Syntax of escapedValue( ) shall be as |
| | defined in ISO/IEC 23003-3. |

TABLE 1
Syntax of voxSceneDiffractionPreComputedPath Data( )

| Syntax | No. of bits | Mnemonic |
|---|---|---|
| voxSceneDiffractionPreComputedPathData( ) | | |
| { | | |
| numberOfVoxDiffractionPathData = escapedValue(16, 32, 64) | | |
| for (int i = 0; i < numberOfVoxDiffractionPathData; i ++) { | | |
| voxDiffractionPathStartVoxelPacked[i]; | NbitsMap | uimsbf |
| voxDiffractionPathEndVoxelPacked[i]; | NbitsMap | uimsbf |
| voxDiffractionPathDataExistFlag[i]; | 1 | bslbf |
| if (voxDiffractionPathDataExistFlag[i] == 1) { | | |
| voxDiffractionSourceDirectionPacked[i]; | NbitsMap | uimsbf |
| voxDiffractionPathLength[i][j]; | 16 | uimsbf |
| } | | |
| } | | |
| } | | |

Note:
NbitsMap = ceil(log2(voxSceneDimensions[1]*voxSceneDimensions[2]-1)

The variables retrieved from the voxSceneDiffractionPreComputedPathData( ) (e.g., as in FIG. 6) are further processed to output the diffraction information N₃.

A technical benefit and effect according to techniques of the present disclosure is that the scene state identifier or other information derived from the scene state may be used to avoid application of the diffraction modeling tools or rendering tools if the corresponding processing was already done for this scene state and the diffraction information or 3DoF auralizer data are available. In this scenario the renderer can access the diffraction information/3DoF auralizer data (for a known scene state) without application of the rendering tools by:
re-using the data calculated before (precomputed), or
applying the data calculated by another renderer.

A technical benefit an effect is thus that techniques according to the present disclosure relate to lossless functionality aiming at the low complexity mode (complexity vs bitrate).

To fully implement such scheme, the present disclosure proposes to provide the processing chain for processing audio scene information for audio rendering (e.g., in a decoder/renderer) with an interface for providing/outputting the diffraction information for later use or use by a different decoder/renderer. This interface is understood to be a data interface for outputting data in a predefined format, to allow for consistent re-use especially by other decoders/renderers. The interface may be implemented and/or utilized in any combination of software and hardware.

Specifically, this may relate to providing/outputting a data element that comprises the diffraction information and information on the scene state, such as the scene state identifier, for example. The data element may have a predefined format, for example with predefined data fields. Using this interface, the processing chain can provide the computed diffraction information or 3DoF auralizer data together with the scene state identifier to other decoders/renderers and/or store it for later re-use.

Example 1: if the decoder/renderer has obtained diffraction information (e.g., a diffraction path) for a given user position (listener location), the decoder/renderer can re-use it until the user leaves the corresponding voxel volume (or the scene description is updated).

Example 2: If the computed diffraction information corresponds to a scene state unknown to the other decoders, they may re-use the diffraction information and avoid running their own diffraction modeling tools or rendering tools.

Exchange and sharing of diffraction information among different decoders can be done using a database, which can be included into the bitstream (to be accessed, for example, via application request).

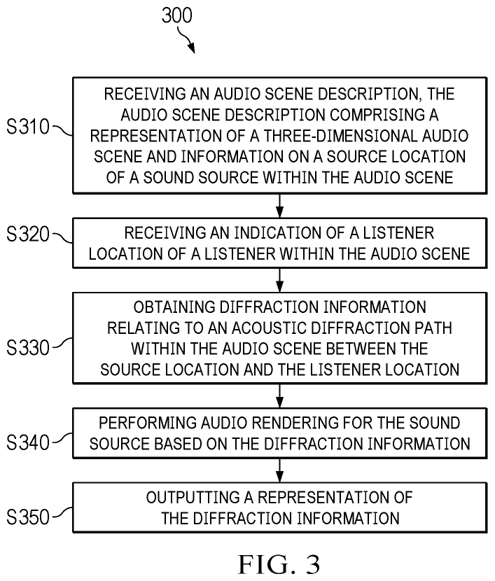

FIG. 3 is a flowchart showing an example of a method 300 of processing audio scene information for audio rendering in accordance with embodiments of the present disclosure. Method 300 may be implemented in software, hardware, or combinations thereof. For example, the processing chain 100 may be implemented by a renderer/decoder coupled to AR/VR/MR/XR equipment, such as AR/VR/MR/XR goggles. Specific implementations may include game consoles, set-top-boxes, personal computers, etc.

Method 300 comprises steps S310 through S350 that may be performed, for example, by a decoder/renderer. These steps may be performed, for example, whenever the scene state changes. With the scene state understood as relating to or comprising the listener location 210 and the audio scene description (including the representation of the three-dimensional audio scene and the source location 220), for example implemented by scene state N₁ above, a change of the scene state could relate to one or more of a change of the listener location 210, a change of the source location, and a change of the (representation of the) three-dimensional audio scene. Alternatively, steps S310 through S350 may be performed for each of a plurality of processing cycles of a decoder/renderer. If the audio scene description is unchanged, step S310 may however be omitted. It is also to be understood that steps S310 through S350 do not need to be performed in the order shown in FIG. 3.

At step S310, an audio scene description is received. The audio scene description comprises a representation of a three-dimensional audio scene and information on a source location of a sound source within the audio scene. For example, the audio scene description may comprise elements S_{VOX} and VoxDataDiffractionMap defined above, for example.

At step S320, information of a listener location of a listener within the audio scene is received. The listener location may correspond to element L_{VOX} defined above, for example.

At step S330, diffraction information relating to an acoustic diffraction path within the audio scene between the source location and the listener location is obtained. The obtained diffraction information may be indicative of a virtual source location of a virtual sound source. For example, the virtual source location may have the same direction (e.g., azimuth, or azimuth and elevation), when seen from the listener location, as the diffraction corner C_{VOX}. The virtual source distance may correspond to the length rᵢₙ of the diffraction path. Accordingly, the diffraction information may comprise indications of Cᵥₒₓ and rᵢₙ defined above.

At step S340, audio rendering is performed for the sound source based on the diffraction information. This may include, for example, diffraction modeling.

To this end, a virtual source location of a virtual source may be determined based on the diffraction information. The virtual source may be an audio source that encapsulates effects of acoustic diffraction between the source location and the listener location in the three-dimensional audio scene. For example, the virtual source location may be determined based on C_{VOX} and rᵢₙ by
determining the direction (e.g., azimuth, or azimuth and elevation) of the diffraction corner C_{VOX} when seen from the listener location;
using the determined direction as the virtual source direction of the virtual source when seen from the listener location; and
using the diffraction path length rᵢₙ as
   the virtual source distance of the virtual source from the listener location, or
   the virtual source gain compensation derived from the diffraction and direct path lengths.

Audio rendering may then include rendering the virtual sound source at the virtual source location, for example.

At step S350, a representation of the diffraction information is output. For example, outputting the representation of the diffraction information may comprise outputting a data element comprising the diffraction information and information on the scene state. The scene state may comprise the audio scene description (e.g., Sᵥₒₓ and VoxDataDiffractionMap) and the listener location (e.g., L_{VOX}).

The output may be provided to a look up table (LUT). The LUT includes, as its entries, different items of diffraction information indexed with information on respective scene states (e.g., indexed with respective scene state identifiers). This LUT thus may be said to include the diffraction information and information on the scene state. The LUT can be stored and/or provided to be later retrieved, for example by other decoders, from a bitstream or from a shared storage (e.g., cloud or server based), for example by application request. A hash value of the scene state or the scene state identifier can be used to retrieve the actually desired entry from the LUT.

Further, the representation of the diffraction information may be output to a bitstream (e.g., outgoing bitstream) and/or to a storage (e.g., a memory, cache, file, etc.). The storage may be local or it may be shared (e.g., cloud based). In general, the representation of the diffraction information may be output to a suitable medium for storing digital information or computer related information. The output may at least partially be directed to an external or shared data source or data repository.

In some implementations, the representation of the diffraction information may be output as part of a voxSceneDiffractionPreComputedPathData( ) syntax element according to ISO/IEC 23090-4 (Coded representation of immersive media—Part 4: MPEG-I immersive audio, https://www.iso.org/standard/84711.html), or according to any future standard deriving therefrom.

For example, the voxSceneDiffractionMap( ) syntax element may be given by Table 2.

TABLE 2
Syntax of voxSceneDiffraction Map( )

| Syntax | No. of bits | Mnemonic |
|---|---|---|
| voxSceneDiffractionMap( ) | | |
| { | | |
| numberOfVoxDiffractionMapElements = | | |
| escapedValue(8, 16, 32) | | |
| for (int i = 0; i < numberOfVoxDiffractionMapElements; i | | |
| ++) { | | |
| voxDiffractionMapValue[i]; | 1 | bslbf |
| voxDiffractionMapPosPackedS[i]; | NbitsMap | uimsbf |
| voxDiffractionMapPosPackedE[i]; | NbitsMap | uimsbf |
| } | | |
| voxSceneDiffractionPreComputedPathData( ); | | |
| } | | |

Note:
NbitsMap = ceil(log2(voxSceneDimensions[1]*voxSceneDimensions[2]-1)

voxSceneDiffractionMap( ) provides a compact representation of a 2D diffraction map (VoxDataDiffractionMap). This 2D representation is similar to the 3D representation used for the voxel-based 3D audio scene.

A MapElement is defined by 2 points (x,y-indices) on the diffraction map and a corresponding value. The two points span a rectangle and all covered grid cells are assigned the value voxDiffractionMap Value.

The bitstream element numberOfVoxDiffractionMapElements signifies the number of MapElements.

The bitstream element voxDiffractionMap Value signifies the binary value controlling the path finding algorithm. It is useful because the value indicates whether a path can go through the grid cell or not. This value is defined for all entries on the diffraction map.

The bitstream element voxDiffractionMapPosPackedS signifies a packed representation of 2 indices of the start grid cell of a MapElement. It may be an array that illustrates a collection of all start grid cells.

The bitstream element voxDiffractionMapPosPackedE signifies a packed representation of 2 indices of the end grid cell of a MapElement. It may be an array that illustrates a collection of all end grid cells.

Both the voxDiffractionMapPosPackedS and voxDiffractionMapPosPackedE are useful because they allow for a compact representation of the data where a single voxDiffractionMap Value is used for all grid cells between these two variables.

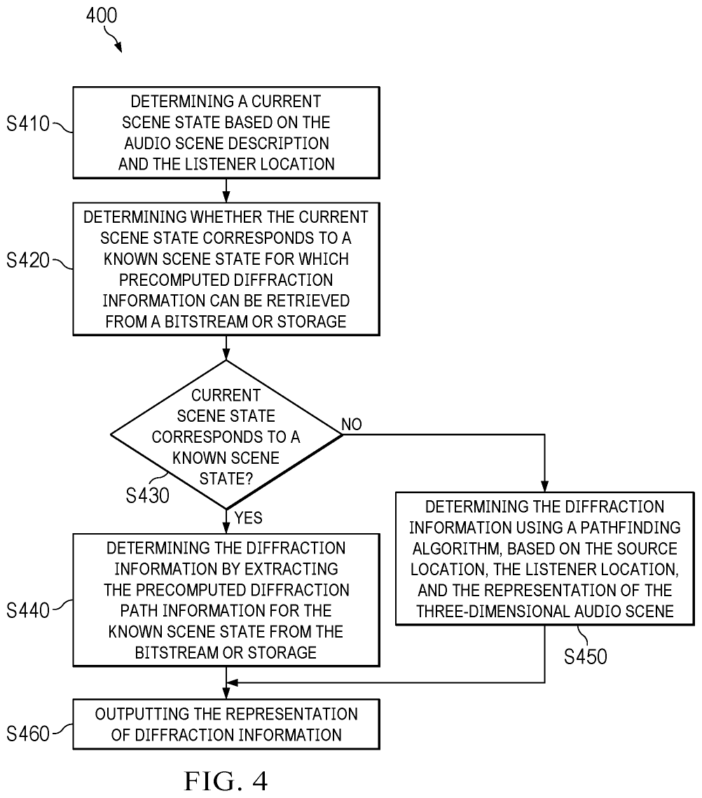

FIG. 4 is a flowchart illustrating an example of a method 400 including steps that may be performed for implementing steps of method 300. Method 400 comprises steps S410 through S460. Of these, steps S410 through S450 may implement step 330 of method 300. Further, step S460 may correspond to step S350.

At step S410, a current scene state is determined based on the audio scene description and the listener location.

At step S420, it is determined whether the current scene state corresponds to a known scene state for which precomputed diffraction information is available (e.g., can be retrieved). The precomputed diffraction information may be retrieved from a bitstream (incoming bitstream) or storage (including, in particular, an external or shared storage), for example. Determining whether the current scene state corresponds to a known scene state may comprise determining a hash value based on the current scene state. It may further comprise comparing the hash value of the current scene state against hash values of known (e.g., previously encountered) scene states.

If it is determined that the current scene state corresponds to a known scene state (YES at step S430), the method proceeds to step S440.

At step S440, the diffraction information is determined by extracting the precomputed diffraction information for the known scene state from the bitstream or storage. The storage may relate to local storage (e.g., memory, cache, file, etc.) or to a shared storage (e.g., cloud storage, server storage).

Extracting the precomputed diffraction information for the known scene state may include receiving a look up table or an entry of a look up table from the bitstream (incoming bitstream) or storage. The look up table may be seen as a representation of the diffraction information. It may comprise a plurality of items of precomputed diffraction information, each associated with a respective known scene state. The precomputed diffraction information and the associated known scene state may correspond to the aforementioned data elements. The known scene state may comprise or be indicative of a known audio scene description and a known listener location.

Selecting the relevant entry of a received look up table, or selecting the relevant entry to be received (if not all of the look up table, but only an entry thereof is received) may involve using hash values, as described above.

On the other hand, if it is determined that the current scene state does not correspond to a known scene state (NO at step S430), the method proceeds to step S450.

At step S450, the diffraction information is determined using a pathfinding algorithm, based on the source location, the listener location, and the representation of the three-dimensional audio scene. This may be done in accordance with the procedure described above with reference to FIG. 2.

At step S460, the diffraction information obtained via step S440 or step S450 is output. This step may correspond to step S350 described above.

In summary, the proposed method may comprise (inter alia) the following:
Check if the pre-computed diffraction path information (i.e., pre-computed diffraction information) can be retrieved from cache and re-applied for the current scene state and listener position.
Check if the pre-computed diffraction path information (i.e., precomputed diffraction information) for the current scene state can be obtained from memory cache or bitstream and re-applied.

Therein, the scene state is defined via the input parameters Lᵥₒₓ, Sᵥₒₓ, VoxDataDiffractionMap for the function DiffractionDirectionCalculation( ) comprising the path-finding algorithm, voxel Cᵥₒₓ selection and diffraction path length estimation steps.

The diffraction path information (e.g., diffraction information) is defined via the output parameters Cᵥₒₓ, rᵢₙ. This diffraction path information, if it is available, can be directly obtained from the bitstream syntax voxSceneDiffractionPreComputedPathData( ) for the corresponding scene state to avoid the function DiffractionDirectionCalculation( ) call.

When the diffraction path information Cᵥₒₓ, rᵢₙ are obtained for the current scene state Lᵥₒₓ, Sᵥₒₓ, VoxDataDiffractionMap, this information can be cached in memory (and provided outside the renderer) for later re-use by the renderer (or other renderer instances).

In other words, “Diffracted path finding” according to the disclosure (e.g., embodied by method 300 and/or method 400) may involve the following processing:
Check if the pre-computed diffraction path information for the current scene state can be obtained from memory cache or bitstream and re-applied.
The scene state is defined via the input parameters Lᵥₒₓ, Sᵥₒₓ, VoxDataDiffractionMap for the function DiffractionDirectionCalculation( ) comprising the path-finding algorithm, voxel Cᵥₒₓ selection and diffraction path length estimation steps.

[Cᵥₒₓ,rᵢₙ]=DiffractionDirectionCalculation(Lᵥₒₓ,Sᵥₒₓ,VoxDataDiffractionMap)
The diffraction path information is defined via the output parameters Cᵥₒₓ, rᵢₙ. This diffraction path information, if it is available, can be directly obtained from the bitstream syntax voxSceneDiffractionPreComputedPathData( ) for the corresponding scene state to avoid the function DiffractionDirectionCalculation( ) call.
When the diffraction path information Cᵥₒₓ, rᵢₙ are obtained for the current scene state Lᵥₒₓ, Sᵥₒₓ, VoxDataDiffractionMap, this information can be cached in memory (and provided outside the renderer) for later re-use by the renderer (or other renderer instances).

In the above, a bitstream syntax definition may be written in a function( ) style in MPEG standard document. It defines how to read/parse data (bitstream elements) from the bitstream. In this case, it is used to obtain necessary variables/information to recover the diffraction path information.

FIG. 5, FIG. 6, and FIG. 7 show examples of a processing chain 500 in accordance with the above that can be used for processing audio scene information for audio rendering. Specifically, the processing chain 500 can be used for converting voxel related data into parameters and signals needed for auralization.

FIG. 5 relates to the case that the current scene state is an unknown scene state. Different from the processing chain 100 of FIG. 1, the bitstream/memory 510 additionally includes data elements comprising diffraction information and associated scene states, for example in the form of look up tables, as described above.

Same as the processing chain 100, the processing chain 500 receives an audio scene description 20 from the bitstream (or storage/memory) 510. The processing chain 500 further receives an indication of a user position (listener location) 30 of a user (listener) within the audio scene.

The diffraction direction calculation block (diffraction calculation block) 40 for determining (e.g., calculating) diffraction information and the diffraction modeling tool 50 for applying diffraction modeling and optionally occlusion modeling, based on the diffraction information, may be the same as for the processing chain 100.

However, different from the processing chain 100 of FIG. 1, the audio scene description 20 and the listener location 30 are used to determine a scene state 515 or scene state identifier. This scene state 515 (e.g., scene state N₁ defined above) or scene state identifier (e.g., HASH(N₁)) is provided/input to a scene state analyzing block 520 that determines whether the current scene state 515 corresponds to a known scene state 530 (yes at block 535) or not (no at block 535). In the present example, the current scene state 515 does not correspond to a known scene state (i.e., the current scene state 515 is an unknown scene state). Thus, the audio scene description 20 and the listener location 30 are input to the diffraction direction calculation block 40, in the same manner as for the processing chain 100, for generating the diffraction information 550. Subsequently, the diffraction information 550 is used for rendering/diffraction modeling, as in the case of processing chain 100. Additionally however, the diffraction information 550 (e.g., diffraction information N₂ or quantized version N₃ thereof as defined above) is output via an interface, for later re-use by the renderer or other (external) rendering instances. Specifically, the diffraction information 550 may be output together with the corresponding scene state via an output interface 555 to the bitstream (or memory/storage) 510.

FIG. 6 relates to the case of that the current scene state 515 is a known scene state.

Again, the current scene state 515 is provided/input to the scene state analyzing block 520 to determine whether the current scene state 515 corresponds to a known scene state 530 or not. In the present example, the current scene state 515 corresponds to a known scene state. Thus, instead of inputting the audio scene description 20 and the listener location 30 to the diffraction direction calculation block 40 for calculating/generating the diffraction information, the diffraction information is extracted/received from the bitstream (or storage/memory) 510, as described above (e.g., via step S450 of method 400). Still, even though the diffraction information is not locally calculated, it may be output to the bitstream (or memory/storage) 510, as in the case of FIG. 5. The reason is that if the diffraction information is obtained from one source (e.g., among the bitstream or storage), it can be made available to the respective other source(s) in this way.

FIG. 7 shows the full processing chain 500, including data paths for both a known and an unknown scene state 515.

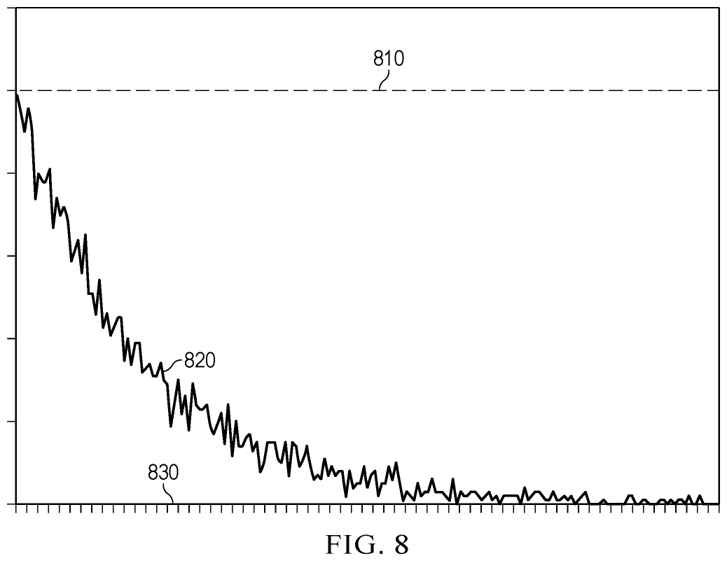

FIG. 8 is a diagram illustrating complexity measures for different implementations of processing audio scene information or audio rendering as functions of time, assuming a simple maze as the audio scene. It is further assumed that the user randomly moves through the maze, thus revisiting previously visited locations. Graph 810 relates to the case that no pre-computed diffraction information whatsoever is available (e.g., no diffraction information provided with the bitstream, memory/cache disabled). In this case, the computational load on the renderer is substantially constant and comparatively high. Graph 820 relates to the case that pre-computed diffraction information is locally available (e.g., no diffraction information provided with the bitstream, local memory/cache enabled). In this case, the processing load on the renderer decays over time, since more and more items of diffraction information are locally accumulated. In other words, more and more scene states that are encountered will relate to (locally) known scene states. Graph 830 finally relates to the case that pre-computed diffraction information is externally provided (e.g., full diffraction information provided with the bitstream). In this case, the computation load on the renderer is constantly low, as a significant portion of scene states relates to known scene states and the diffraction information can be externally retrieved (e.g., from the bitstream or by request from an external/shared storage), without local calculation.

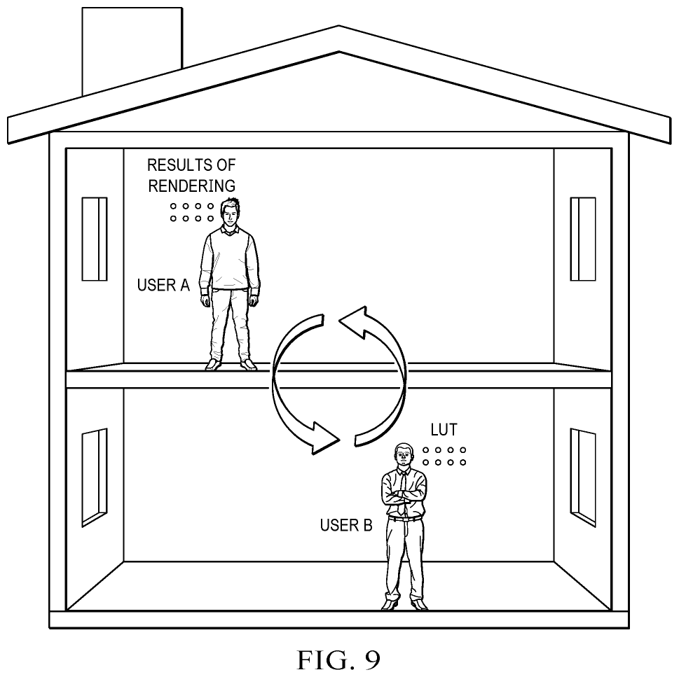

FIG. 9 schematically illustrates an example of a possible use case for techniques according to embodiments of the disclosure. Shown are two listeners (users) A and B at different locations within an audio scene (e.g., a house with different areas and levels). Users A and B may be users that individually or jointly explore a VR environment including the audio scene, for example as part of a game, virtual tour, etc. The users exploring a common VR environment may be running a social VR, for example. Having different listener locations within the audio scene, users A and B will produce different rendering results and different diffraction information. The present disclosure foresees that each user (or their respective device/decoder/renderer) makes their calculated diffraction information available to other users. Once user B enters an area of the audio scene in which user A had been present previously, they may benefit from user A's precomputed diffraction information, and vice versa. For example, user A's diffraction information may be made available to user B via a LUT that indexes different items of diffraction information with corresponding scene states or scene state identifiers. By exchanging diffraction information between different devices/decoders/renderers, computational load for both users' devices/decoders/renderers can be reduced, depending on their movement patterns within the audio scene.

In addition, since users (listeners) tend to behave similarly, diffraction information (diffraction data) is accumulated in particular for relevant (e.g., frequently occurring) scene states. This would be very difficult to achieve for encoder-side precomputation of diffraction information since the encoder does not have access to the actual listener positions and therefore can only assume them. Further, use of data storage (e.g., physical/shared storage or bitstream bandwidth) would be much more inefficient for encoder-side precomputation, due to part of the precomputed diffraction information relating to irrelevant or less relevant scene states in this case.

For example, the proposed functionality and techniques can create LUTs that correspond to the real 6DoF behavior of users (and not an assumed one at the encoder side), and thus may be said to relate to smart user-oriented LUT creation.

### Efficient Representation of Voxel-Based Audio Scenes

Current representation formats for voxel-based scenes include *.vox, *.binvox, etc., for example. The present disclosure provides, for example for the MPEG-I Audio standard, the following compression approach. A set of voxels having the same acoustic property (e.g., same material properties) or the same audio rendering instructions can be identified by two points forming a cuboid region on the voxel grid. All voxels in this cuboid region share the acoustic property or audio rendering instruction set assigned to the corresponding two points as follows.

That is, the scene geometry is determined by a set of such pairs of points (as examples of representations of geometric regions), for example:

<VoxBox id=“V_ID”material=“P_ID”Point_S=“X1Y1Z1”Point_E=“X2Y2Z2”/>

where V_ID is a cuboid voxel block element identifier; P_ID is acoustic property or audio rendering instruction set identifier (e.g., occlusion, reflection, RT60 data); X1, Y1, Z1 and X2, Y2, Z2 are the grid indices of corresponding two points defining the cuboid voxel block element. Accordingly, <VoxBox id, material, Point_S, Point_E/> may correspond to the scene element defined above, that is, a geometric region (e.g., defined by the pair of points) together with its voxel property (e.g., P_ID) and optionally its identifier (e.g., V_ID).

The voxel size may be determined by the number of voxels as

$$< VoxSize size = {}^{‶} {N}^{″} / >$$

where N is the number of voxels along the first longest scene dimension.

Accordingly, a voxel-based representation of an audio scene according to embodiments of the disclosure may include representations or indications of one or more cuboid geometric regions (cuboid space regions, cuboid volumes) that have identical (i.e., same, common) acoustic properties (e.g., material, absorption coefficients, reflection coefficients, etc.) or identical rendering instructions. The acoustic property or rendering instruction for a given voxel may be non-limiting examples of a voxel property of the given voxel. The representations of indications of the cuboid geometric regions may relate to scene elements, for example. It is understood that the cuboid regions are each non-trivial, in the sense that they each comprise more than a single voxel, and consist of a connected (i.e., contiguous) set of voxels.

The shape of each of these geometric regions can be defined by first and second boundary voxels (e.g., the above pair of points). These first and second boundary voxels may relate to diametral corners (extreme-corner voxels) of the cuboid, such as the extreme-corner voxel with the smallest x, y, z coordinate values or coordinate indices, and the extreme-corner voxel with the largest x, y, z coordinate values or coordinate indices, for example. Other choices of the diametral extreme-corner voxels are feasible as well.

Further, in the voxel-based representation, each geometric region may be represented by at least an indication of the first and second boundary voxels and an indication of the common voxel property of the voxels within the geometric region. Additionally, the representation of the geometric region may include an identifier (ID) of the geometric region.

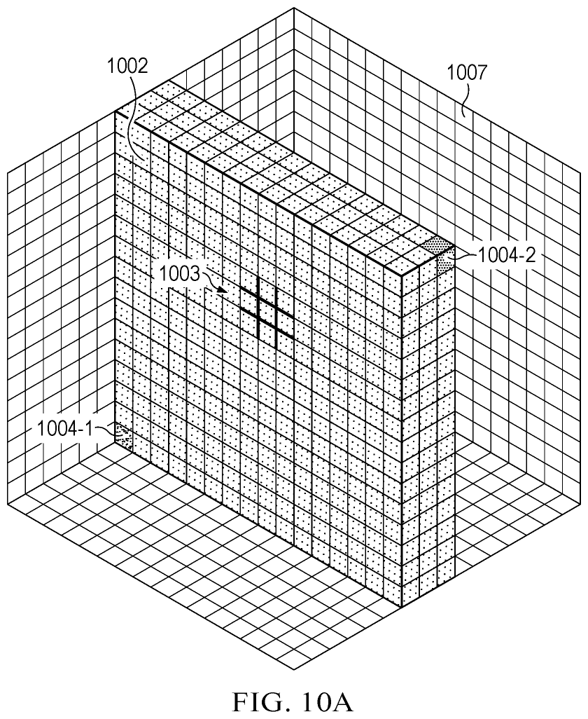

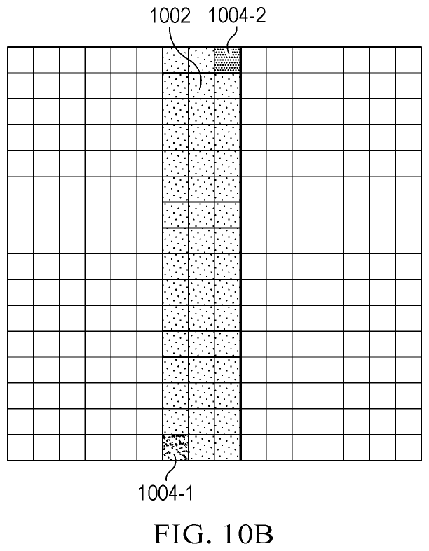

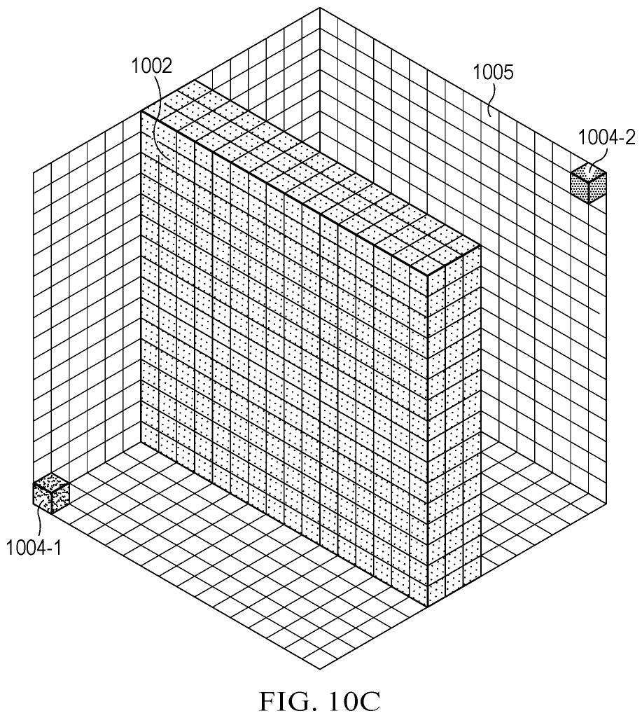

FIG. 10A shows an example of a geometric region 1002 in a voxel grid 1007. The geometric region 1002 comprises a plurality of voxels 1003 that form a cuboid. The shape or size of the geometric region can be represented by first and second boundary voxels 1004-1, 1004-2, such as extreme-corners or extreme-corner voxels, which in this example correspond to the lower left front corner and the upper right back corner, respectively. FIG. 10B shows a side view of the geometric region 1002, looking from the front right in FIG. 10A.

For the proposed compression approach, each next pair of points (i.e., each next geometric region) may re-define the voxel properties in the corresponding cuboid region. That is, voxel properties of subsequent geometric regions may overwrite any previously assigned voxel properties for the voxels of the subsequent geometric region. In one implementation, smaller geometric regions that are fully contained within larger geometric regions may redefine or overwrite voxel properties of voxels in the smaller geometric region with the voxel property of the smaller geometric region. Here, it is understood that corresponding voxel properties are overwritten, while any other voxel properties are maintained. For example, if the subsequent geometric region defines acoustic properties of its voxels, these acoustic properties will be used to overwrite the acoustic properties defined for the voxels of the previous geometric region, but any rendering instructions of the voxels of the previous geometric region will be maintained.

As noted above, the order among geometric regions may be derived from whether geometric regions are fully contained within each other, may be derived from an order of representations or indications of the geometric regions in a bitstream, or may be derived from a predefined order referencing identifiers (IDs) of the geometric regions, for example.

FIG. 10C schematically illustrates how voxel properties assigned to a first geometric region defined by extreme-corner voxels 1004-1, 1004-2 may be overwritten by voxel properties of a second geometric region 1002.

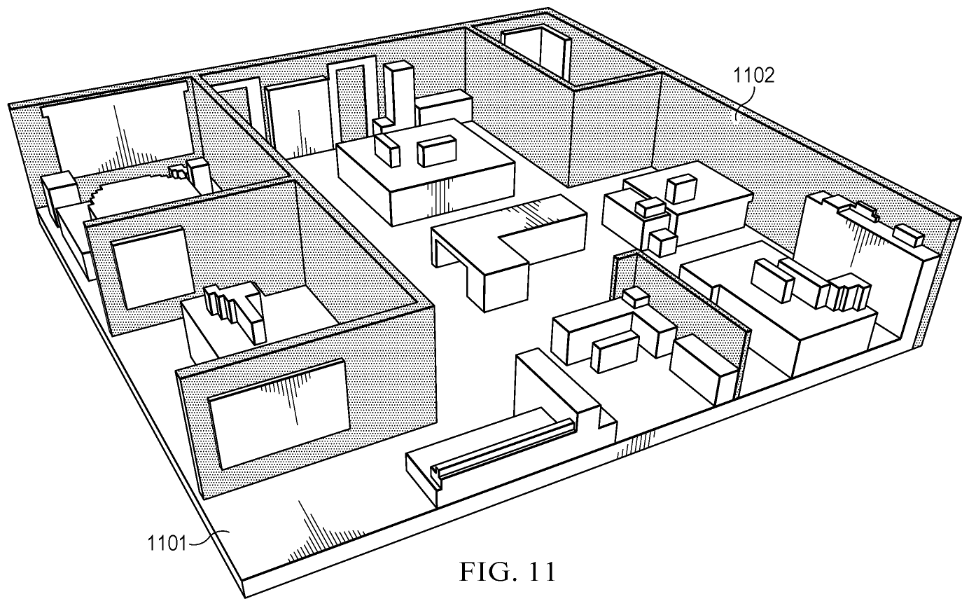

FIG. 11 schematically illustrates an example of a voxel-based description of a three-dimensional audio scene that includes a plurality of cuboid volumes of common voxel properties, potentially with smaller cuboid sub-volumes that redefine voxel properties. The audio scene may include voxels 1101 that are local sound occluders that occlude inside a given acoustic environment of the audio scene. The audio scene may additionally include voxels 1102 that are local sound occluders that separate acoustic environments from each other.

### Representation of Voxel Coordinates Indices

The following efficient representation of voxel indices may be applicable for transmission or storage of both voxel grid and Diffraction Map (VoxDataDiffractionMap) entries, for example. It may substitute any fixed-length representations of voxel indices (voxel coordinates).

The following steps may be performed in the context of the proposed representation:

Step 1: Determine the amount (i.e., number, count) of bits needed for the current grid resolution/diffraction map dimension. For a three dimensional voxel grid and a two dimensional diffraction map, these numbers NbitsVox and NbitsMap, respectively, may be determined for example as follows:

$$NbitsVox = ceil ( log 2 ( L * W * H - 1 ) )$$

$$NbitsMap = ceil ( log 2 ( L * W - 1 ) ) ,$$

where L, W, H (Length, Width, Height) is the dimension of voxel grid and diffraction map. The values may differ for the voxel grid and diffraction map.

Step 1 may apply to both the encoder side and the decoder side.

Step 2: the voxel indices (x, y, z) and diffraction map indices (x, y) are mapped onto a packed representation index (Idx) and encoded using Nbits_vox and Nbits_map bits, respectively. In one embodiment (x, y, z) is zero-based and the packed representation indices may range from 0 to L*W*H−1 for voxels and from 0 to L*W−1 for the diffraction map. The mapping from the indices (x, y, z) onto the packed representation indices may be for example as follows:

$$Idx ( x , y , z ) = ( x - 1 ) + ( ( y - 1 ) * L ) + ( ( z - 1 ) * L * W ) .$$

Step 2 may be performed at the encoder side only.

In the above, the packed representation index is an index that can uniquely identify a voxel in the voxel grid or diffraction map. Put differently, the voxels in the voxel grid may have assigned thereto a unique consecutive index, so that each voxel in the voxel grid can be uniquely identified by a single integer number. Accordingly, a packed representation index may be used for any indication of a voxel location in the voxel grid or in a two-dimensional map. In particular, the packed representation index may be used for indicating any voxel locations mentioned throughout the disclosure.

The assignment of unique indices to the voxels may be according to a predefined pattern. For example, the voxel grid may be scanned/traversed in x, y, and z directions, in this order, for consecutively assigning the unique index to respective voxels.

The mapping from the packed representation indices back onto the voxel and diffraction map indices may be for example as follows:

$$x = floor ( Idx ) \% L + 1$$

$$y = floor ( Idx / L ) \% W + 1$$

$$z = floor ( Idx / L / W ) \% H + 1 ,$$

where % denotes the modulo operator.

In line with the above, the bitstream payload element voxSceneDiffractionPreComputedPathData( ) given in Table 1 may use the following pseudo code:

```
if (voxSceneDiffractionMapPresentFlag == 1) {
  for (int i = 0; i < numberOfVoxDiffractionMapElements, i++) {
    PackedPosS[i] = voxDiffractionMapPosPackedS[i]
    PackedPosE[i] = voxDiffractionMapPosPackedE[i]
    for (int j = 0, j < 2, j++) {
      voxDiffractionMapPosS[i][j] = mod(PackedPosS[i], voxSceneDimensions[j]) + 1
      PackedPosS[i] = floor(PackedPosS[i] / voxSceneDimensions[j])
      voxDiffractionMapPosE[i][j] = mod(PackedPosE[i], voxSceneDimensions[j]) +
1
      PackedPosE[i] = floor(PackedPosE[i] / voxSceneDimensions[j])
      start[j] = voxDiffractionMapPosS[i][j]
      end[j] = voxDiffractionMapPosE[i][j]
    }
    for (int x = start[0], x <= end[0], x++) {
      for (int y = start[1], y <= end[1], y++) {
        VoxDataDiffractionMap[x][y] = voxDiffractionMapValue[i]
      }
    }
  }
} else {
  H = round(0.5*voxSceneDimensions[2])
  for (int x = 0, x < voxSceneDimensions[0], x++) {
    for (int y = 0, y < voxSceneDimensions[1], y++) {
      VoxDataDiffractionMap[x][y] = VoxDataMatrix[x][y][H]
    }
  }
}
```

where voxDiffractionMapPosPackedS and voxDiffractionMapPosPackedE indicated packed representation indices.

### Entropy Coding

An entropy coding method can be applied to the sequence of integer numbers representing acoustic properties, voxel grid coordinates, voxel grid indices, etc.

For example, an entropy encoding method can be applied to the sequence of integer numbers (representing acoustic property or audio rendering instruction set reference P_ID and grid indices X1, Y1, Z1 and X2, Y2, Z2) described above, or to packed representations thereof. Further, entropy coding may be applied to a sequence if integer numbers derived from the aforementioned representation of diffraction path information.

Accordingly, it is a technical benefit and advantage of voxel-based scene representations as described herein to allow creating complex dynamic scenes and encode them efficiently.

### Apparatus

While methods and processing chains have been described above, it is understood that the present disclosure likewise relates to apparatus (e.g., computer apparatus or apparatus having processing capability in general) for implementing these methods and processing chains (or techniques in general).

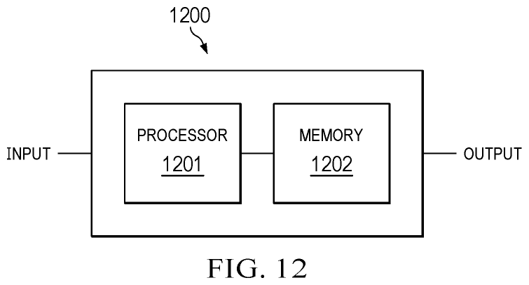

An example of such apparatus 1200 is schematically illustrated in FIG. 12. The apparatus 1200 comprises a processor 1201 and a memory 1202 coupled to the processor 1201. The memory 1202 may store instructions for execution by the processor 1201. The processor 1201 may be adapted to implement the processing chains described throughout the disclosure and/or to perform methods (e.g., methods of processing audio scene information for audio rendering) described throughout the disclosure. The apparatus 1200 may receive inputs (e.g., audio scene description, listener location, etc.) and generate outputs (e.g., representations of diffraction information, etc.).

### Interpretation

Aspects of the systems described herein may be implemented in an appropriate computer-based sound processing network environment (e.g., server or cloud environment) for processing digital or digitized audio files. Portions of these systems may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Specifically, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, computer-implemented neural networks described herein can include one or more electronic processors, one or more computer-readable medium modules, one or more input/output interfaces, and various connections (e.g., a system bus) connecting the various components.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

### Enumerated Example Embodiments

Various Aspects an implementations of the invention may also be appreciated from the following enumerated example embodiments (EEEs), which are not claims.

EEE1. A method of processing audio scene information for audio rendering, the method comprising:
receiving an audio scene description, the audio scene description comprising a representation of a three-dimensional audio scene and information on a source location of a sound source within the audio scene;
receiving an indication of a listener location of a listener within the audio scene;
obtaining diffraction information relating to an acoustic diffraction path within the audio scene between the source location and the listener location;
performing audio rendering for the sound source based on the diffraction information; and
outputting a representation of the diffraction information.

EEE2. The method according to EEE1, wherein outputting the representation of the diffraction information comprises outputting a data element comprising the diffraction information and information on a scene state, the scene state comprising the audio scene description and the listener location.

EEE3. The method according to EEE1 or EEE2, wherein the representation of the diffraction information is output to a bitstream and/or to a storage.

EEE4. The method according to any one of EEE1 to EEE3, wherein the diffraction information is output for later re-use for audio rendering by the same rendering instance or for later re-use by another rendering instance.

EEE5. The method according to any one of EEE1 to EEE4, wherein the representation of the diffraction information is output as part of a voxSceneDiffractionPreComputedPathData( ) syntax element according to ISO/IEC 23090-4 or any standard deriving from ISO/IEC 23090-4.

EEE6. The method according to any one of EEE1 to EEE5, wherein the diffraction information is indicative of a virtual source location of a virtual sound source.

EEE7. The method according to any one of EEE1 to EEE6, wherein the representation of the three-dimensional audio scene is a voxel-based representation; and wherein the representation of the three-dimensional audio scene comprises one or more indications of cuboid volumes in a voxel grid and wherein each such indication comprises information on a pair of extreme-corner voxels of the cuboid volume and information on a common voxel property of the voxels in the cuboid volume.

EEE8. The method according to EEE7, wherein the information on the pair of extreme-corner voxels of the cuboid volume comprises indications of respective voxel indices assigned to the extreme-corner voxels, the voxels of the voxel-based audio scene representation having uniquely assigned consecutive voxel indices.

EEE9. The method according to any one of EEE1 to EEE6, wherein the representation of the three-dimensional audio scene is a voxel-based representation;
wherein the diffraction information comprises an indication of a location of a voxel that is located on or on the proximity of the diffraction path and an indication of a length of the diffraction path; and
wherein the indication of the location of the voxel located on or on the proximity of the diffraction path is an indication of a voxel index assigned to said voxel, the voxels of the voxel-based audio scene representation having uniquely assigned consecutive voxel indices.

EEE10. The method according to any one of EEE1 to EEE9, further comprising:
determining a current scene state based on the audio scene description and the listener location.

EEE11. The method according to EEE10, further comprising:
determining whether the current scene state corresponds to a known scene state for which precomputed diffraction information can be retrieved.

EEE12. The method according to EEE11, wherein determining whether the current scene state corresponds to a known scene state comprises determining a hash value based on the current scene state.

EEE13. The method according to EEE11 or EEE12, further comprising:
if it is determined that the current scene state corresponds to a known scene state, determining the diffraction information by extracting the precomputed diffraction information for the known scene state from a bitstream or storage.

EEE14. The method according to any one of EEE11 to EEE13, further comprising:
if it is determined that the current scene state does not correspond to a known scene state, determining the diffraction information using a pathfinding algorithm, based on the source location, the listener location, and the representation of the three-dimensional audio scene.

EEE15. The method according to any one of EEE1 to EEE14, further comprising: receiving a look up table or an entry of a look up table from a bitstream or storage, the look up table comprising a plurality of items of precomputed diffraction information, each associated with a respective known scene state, the known scene state comprising a known audio scene description and a known listener location.

EEE16. The method according to any one of EEE1 to EEE15, wherein the representation of the three-dimensional audio scene is a voxel-based representation.

EEE17. A method of compressing an audio scene for three-dimensional audio rendering, the method comprising:
obtaining a voxelized representation of the audio scene, the voxelized representation comprising a plurality of voxels arranged in a voxel grid, each voxel having an associated voxel property;
determining, among the voxels of the voxelized representation, a set of voxels that forms a connected geometric region on the voxel grid, wherein the voxels in the geometric region share a common voxel property; and
generating a representation of the audio scene based on the determined set of voxels.

EEE18. The method of EEE17, wherein the geometric region has a cuboid shape, the method further comprising determining, from the plurality of voxels of the voxelized representation, at least a first boundary voxel and a second boundary voxel for the set of voxels, the first boundary voxel and the second boundary voxel defining the cuboid shape of the geometric region.

EEE19. The method of EEE17 or EEE18, wherein the voxel property of each voxel comprises an acoustic property associated with that voxel and/or a set of audio rendering instructions assigned to that voxel, and the common voxel property for the voxels in the geometric region comprises a common acoustic property associated with those voxels and/or a common set of audio rendering instructions assigned to those voxels.

EEE20. The method of any one of EEE17 to EEE19, further comprising determining, for the geometric region, at least one scene element parameter comprising one or more of: a scene element identifier, an acoustic property identifier and/or audio rendering instruction set identifier, and indices of the corresponding first and second boundary voxels defining the geometric region.

EEE21. The method of EEE20, further comprising applying entropy coding to the at least one scene element parameter for the geometric region.

EEE22. The method of EEE20 or EEE21, further comprising outputting a bitstream including the at least one scene element parameter for determining the set of voxels associated with the geometric region for a compressed representation of the audio scene based on the determined set of voxels.

EEE23. The method according to any one of EEE17 to EEE22, wherein the geometric region is related to a scene element within the audio scene.

EEE24. The method according to any one of EEE17 to EEE23, wherein the audio scene comprises a large scene represented by the determined set of voxels, the large scene including a set of sub-scenes, wherein each of the sub-scenes corresponds to a subset of the determined set of voxels, the method further comprising determining, among the determined set of voxels, the subsets of voxels for the corresponding sub-scenes.

EEE25. The method according to any one of EEE17 to EEE24, further comprising applying interpolation of audio voxels in time and/or space.

EEE26. The method according to any one of EEE17 to EEE25, further comprising redefining voxel properties for a subset of the set of voxels associated with a scene sub-element in the geometric region for overwriting the subset with the redefined voxel properties.

EEE27. The method according to any one of EEE17 to EEE26, further comprising determining a superset of voxels including the determined set of voxels, the determined set of voxels associated with a scene sub-element within the geometric region, the method further comprising assigning a new voxel property to the determined set of voxels and overwriting the voxel property of the determined set of voxels with the new voxel property.

EEE28. The method according to any one of EEE17 to EEE27, further comprising determining a voxel size for representing the geometric region, wherein the voxel size is based on a number of voxels along a scene dimension of the geometric region.

EEE29. An apparatus, comprising a processor and a memory coupled to the processor, and storing instructions for the processor, wherein the processor is adapted to carry out the method according to any one of EEE1 to EEE28.

EEE30. A program comprising instructions that, when executed by a processor, cause the processor to carry out the method according to any one of EEE1 to EEE28.

EEE31. A computer-readable storage medium storing the program of EEE30.

1-31. (canceled)

32. A method of processing audio scene information for audio rendering, the method comprising:
receiving an audio scene description, the audio scene description comprising a representation of a three-dimensional audio scene and information on a source location of a sound source within the audio scene, wherein the representation of the three-dimensional audio scene is a voxel-based representation and comprises one or more indications of cuboid volumes in a voxel grid, and wherein each such indication comprises information on a pair of extreme-corner voxels of the cuboid volume and information on a common voxel property of the voxels in the cuboid volume;
receiving an indication of a listener location of a listener within the audio scene;
obtaining diffraction information relating to an acoustic diffraction path within the audio scene between the source location and the listener location;
performing audio rendering for the sound source based on the diffraction information; and
outputting a representation of the diffraction information.

33. The method according to claim 32, wherein outputting the representation of the diffraction information comprises outputting a data element comprising the diffraction information and information on a scene state, the scene state comprising the audio scene description and the listener location.

34. The method according to claim 32, wherein the representation of the diffraction information is output to a bitstream.

35. The method according to claim 32, wherein the diffraction information is output for later re-use for audio rendering by the same rendering instance or for later re-use by another rendering instance.

36. The method according to claim 32, wherein the information on the pair of extreme-corner voxels of the cuboid volume comprises indications of respective voxel indices assigned to the extreme-corner voxels, the voxels of the voxel-based audio scene representation having uniquely assigned consecutive voxel indices.

37. The method according to claim 32, wherein the representation of the three-dimensional audio scene is a voxel-based representation;
wherein the diffraction information comprises an indication of a location of a voxel that is located on or on the proximity of the diffraction path and an indication of a length of the diffraction path; and
wherein the indication of the location of the voxel located on or on the proximity of the diffraction path is an indication of a voxel index assigned to said voxel, the voxels of the voxel-based audio scene representation having uniquely assigned consecutive voxel indices.

38. The method according to claim 32, wherein determining whether the current scene state corresponds to a known scene state comprises determining a hash value based on the current scene state.

39. The method according to claim 32, further comprising:
if it is determined that the current scene state does not correspond to a known scene state, determining the diffraction information using a pathfinding algorithm, based on the source location, the listener location, and the representation of the three-dimensional audio scene.

40. The method according to claim 32, wherein the representation of the three-dimensional audio scene is a voxel-based representation including information on locations and material properties of a plurality of occluder voxels.

41. A method of compressing an audio scene for three-dimensional audio rendering, the method comprising:
obtaining a voxelized representation of the audio scene, the voxelized representation comprising a plurality of voxels arranged in a voxel grid, each voxel having an associated voxel property;
determining, among the voxels of the voxelized representation, a set of voxels that forms a connected geometric region on the voxel grid, wherein the geometric region has a cuboid shape and the voxels in the geometric region share a common voxel property;
determining, from the plurality of voxels of the voxelized representation, at least a first boundary voxel and a second boundary voxel for the set of voxels, the first boundary voxel and the second boundary voxel defining the cuboid shape of the geometric region; and
generating a representation of the audio scene based on the determined set of voxels.

42. The method of claim 41, further comprising determining, for the geometric region, at least one scene element parameter comprising one or more of: a scene element identifier, an acoustic property identifier and/or audio rendering instruction set identifier, and indices of the corresponding first and second boundary voxels defining the geometric region.

43. The method of claim 42, further comprising applying entropy coding to the at least one scene element parameter for the geometric region.

44. The method claim 42, further comprising outputting a bitstream including the at least one scene element parameter for determining the set of voxels associated with the geometric region for a compressed representation of the audio scene based on the determined set of voxels.

45. The method according to claim 41, wherein the geometric region is related to a scene element within the audio scene.

46. The method according to claim 41, wherein the audio scene comprises a large scene represented by the determined set of voxels, the large scene including a set of sub-scenes, wherein each of the sub-scenes corresponds to a subset of the determined set of voxels, the method further comprising determining, among the determined set of voxels, the subsets of voxels for the corresponding sub-scenes.

47. The method according to claim 41, further comprising applying interpolation of audio voxels in time and/or space.

48. The method according to claim 41, further comprising redefining voxel properties for a subset of the set of voxels associated with a scene sub-element in the geometric region for overwriting the subset with the redefined voxel properties.

49. The method according to claim 41, further comprising determining a superset of voxels including the determined set of voxels, the determined set of voxels associated with a scene sub-element within the geometric region, the method further comprising assigning a new voxel property to the determined set of voxels and overwriting the voxel property of the determined set of voxels with the new voxel property.

50. The method according to claim 41, further comprising determining a voxel size for representing the geometric region, wherein the voxel size is based on a number of voxels along a scene dimension of the geometric region.

51. An apparatus comprising a processor and a memory coupled to the processor, and storing instructions for the processor, wherein the processor is adapted to carry out the method according to claim 32.

52. An apparatus, comprising a processor and a memory coupled to the processor, and storing instructions for the processor, wherein the processor is adapted to carry out the method according to claim 41.

53. A non-transitory computer program comprising instructions that, when executed by a processor, cause the processor to carry out the method according to claim 32.

54. A non-transitory computer program comprising instructions that, when executed by a processor, cause the processor to carry out the method according to claim 41.
